(19) United States
(12) Patent Application Publication
(10) Pub. No.: US 2001/0021110 A1
(43) Pub. Date: Sep. 13, 2001

(54) Reflector, method for the production of reflector, and internal-lighting display device

(76) Inventors: Naoki Nakayama, Tendo-City (JP); Kanya Mizufune, Yamagata-city (JP)

Correspondence Address: Attention: Rudolph P Hofmann, Jr., Office of Intellectual Property Counsel, 3M Innovative Properties Company, PO Box 33427, St. Paul, MN, 55133-3427, US

(21) Appl. No.: 09/746,518

(22) Filed: Dec. 22, 2000

(30) Foreign Application Priority Data
Jan. 17, 2000 (JP) 2000-7914

(51) Int. Cl. F21V 7/00

(52) U.S. Cl. 362/247; 362/341; 362/297

(57) ABSTRACT

A reflector having a laminate with a light-transmissive substrate and light-transmissive retroreflective sheet is disclosed. The light-transmissive retroreflective sheet is attached to the substrate to cover the surface of the substrate. The reflector has light transmission properties as a whole, characterized in that, a plurality of depressions are formed on the backside of the substrate. A plurality of projections are formed on a reflection surface of the retroreflective sheet.

### FIELD OF THE INVENTION

The present invention relates to a reflector, a method for the production of a reflector, and an internal-lighting display device. In particular, the present invention relates to a reflector which has light-transmission properties.

### PRIOR ART

Internal-lighting devices (which may also be referred to as internal light-emitting devices), which use light-transmissive retroreflective sheets as reflectors, are widely used. For example, Japanese Patent No. 2,778,731 discloses an internal-lighting display device comprising a housing (closed container) having a built-in light source, and a reflector which comprises a light-transmissive retroreflective sheet provided on the front surface (light-emitting surface) of the housing. An internal light source, which illuminates the reflector from its backside, is provided in the space of the housing.

The above light-transmissive retroreflective sheet is preferably a so-called prism-type retroreflective sheet comprising a number of cube-corner prisms. The prism-type retroreflective sheet has a high light transmission, because the cube-corner prisms are made of light-transmissive polymers or glass. The retroreflectivity of a prism-type retroreflective sheet is developed by the effective use of interfacial reflection between the prism surfaces and an air.

In general, the above retroreflective sheet is provided so that the light-emitting surface (usually, a displaying surface carrying information) of the device has high retroreflectivity. For example, a light-transmissive retroreflective sheet is adhered to the surface of a transparent or semitransparent plastic plate to form a display plate, and then provided on the light-emitting front surface of a housing. The surface and backside of the plastic plate generally are both flat. The surface of the retroreflective sheet may have information to be displayed such as characters, designs, signs, etc., and the surface (reflection surface) of the retroreflective sheet is usually flat.

JP-A-10-280338 discloses a similar internal-lighting sign board, which has a cool cathode tube having a relatively small diameter used as an internal light source, to decrease the thickness of the whole device.

Such an internal-lighting display device comprising a light-transmissive retroreflective sheet has following advantages. That is, the light-emitting surface and displayed information can be seen with a high luminance by the light from the internal light-source of the device. Furthermore, even if the light source has trouble or is exhausted, and cannot emit light, the light-emitting surface and displayed information can be seen with a high luminance by the retroreflection function with light from an external light source. Accordingly, the visibility of the device at night can be maintained for a long time.

Also, a reflector is known which can effectively improve the visibility at night by the illumination with an external light source. For example, JP-A-10-333616 discloses a reflector plate comprising a laminate having a substrate and a retroreflective sheet adhered to the surface of the substrate and a plurality of projections, which are disposed apart from each other on the apexes of geometric plane figures arranged to form regularly repeated patterns and which are covered with the retroreflective sheet.

The above reflector plate is preferably produced by the following method comprising the steps of providing a flat substrate made of an expandable metal or resin as the above substrate, fixing the above retroreflective sheet on the surface of the substrate to form a laminate, and embossing the laminate by pressing an embossing tool having a plurality of projections onto the laminate from the backside of the substrate to form the above projections. This method can precisely and easily form projections having specific shapes, sizes and arrangement.

The above reflector plate has good wide entrance angle reflection properties against external light, and also improved outdoor use properties. Thus, such a reflector plate can improve the visibility at night of external-lighting display devices, which are installed on road sides or corners of tunnels and illuminated with headlights of vehicles such as automobiles for example, traffic signs, delineators, sign boards, etc.

As described above, the reflection properties of the external-lighting display devices have been improved, and external-lighting display devices having increased visibility luminance (reflection luminance) are available. However, it is difficult to increase a luminance on retroreflective sheet surfaces (light-emitting surfaces) of conventional internal-lighting devices with internal light sources. In particular, it is very difficult to increase the internal-lighting luminance in a wide observation angle range.

### SUMMARY

The present disclosure relates to a device and method that address the problems of the prior art. Accordingly, in one aspect, the present disclosure provides a reflector which can effectively increase an internal-lighting luminance of an internal-lighting display device in a wide observation angle range. In another aspect, the present disclosure provides an internal-lighting display device wherein the visibility at night is effectively improved by the increase of both the reflection luminance by external light and the internal-lighting luminance of the device using such a reflector. The entrance and observation angles are taken with reference to a line normal to the light-entering surface (the reflection surface or the opposing surface thereto), of the reflection sheet as a whole. The observation angle is taken with reference to a line normal to the reflection surface of the reflection sheet as a whole.

In one aspect, the present invention provides a reflector comprising a laminate having a light-transmissive substrate and a light-transmissive retroreflective sheet attached to said substrate to cover the surface of said substrate, wherein said reflector has light-transmission properties as a whole, characterized in that, a plurality of depressions are present on the backside of said substrate, and a plurality of projections are present on a reflection surface of said retroreflective sheet, and also a method for the production of the above reflector of the present disclosure, comprising the steps of:

(a) providing a light-transmissive expandable substrate as said substrate,

(b) providing said retroreflective sheet and attaching said retroreflective sheet so that it covers the surface of said expandable substrate to form said laminate,

(c) embossing said laminate to form said depressions on said backside of said substrate, and said projections on the reflection surface of said retroreflective sheet.

In another aspect, the present disclosure provides an internal-lighting display device comprising:

(a) a light source,

(b) a housing having a space which contains a built-in light source, and at least one opening continuous with said space, and

(c) the reflector of the present disclosure, which is provided to cover said opening with the backside of said substrate facing said opening of said housing.

The reflector of the present disclosure comprises a laminate having a substrate and a retroreflective sheet attached to the substrate to cover the surface of the substrate, in which the reflector has light-transmission properties as a whole, and is characterized in that, a plurality of depressions are formed on the backside of the substrate, and a plurality of projections are formed on a reflection surface of the retroreflective sheet. Thus, when the reflector is placed on the front face of an internal-lighting display device, it can effectively increase the internal-lighting luminance on the light-emitting surface (display surface) of the device.

As described above, in conventional internal-lighting display devices, the backside of a light-transmissive retroreflective sheet (that is, a surface which is illuminated with the light from an internal light source) is usually flat. In such a case, when the light from the light source is illuminated from a direction having a relatively small angle from the normal line of the backside of the reflective sheet (that is, a direction relatively close to the normal direction), the light easily propagates through the reflective sheet. On the other hand, the light, which is illuminated from a direction having a relatively large angle from the normal line of the backside of the reflective sheet (that is, a direction relatively remote the normal direction), tends to be reflected by the backside of the sheet. In general, light from a light source is diffusively reflected or scattered in a housing, and then impinges from the backside of a reflective sheet through the housing space. Such diffusively reflected or scattered light is easily reflected on a flat surface, since it contains components in every direction. Therefore, it is difficult to increase the internal-lighting luminance of a conventional internal-lighting display device having the flat backside of the reflective sheet.

Since a plurality of depressions are formed on the backside of a substrate which is illuminated by the light of a light source, the depressions may function as converging lenses to increase the amount of light introduced in a retroreflective sheet. Accordingly, the internal-lighting luminance on the light-emitting surface of the device can be effectively increased.

The effective increase of the internal-lighting luminance in a wide observation angle range may be due to that a plurality of projections, which are formed on the reflection surface (acting as a light-emitting surface in the case of internal-lighting) of a retroreflective sheet, may function effectively. A plurality of projections provided on the reflection surface function like diffusing lenses and thus allow light to illuminate in directions in a wide-angle range. The projections on the reflection surface also function to increase the reflection luminance with respect to the entrance light from directions in a wide-angle range, when they reflect external light. Thus, the visibility at night can be effectively improved both by internal-lighting and by external-lighting, when the device is illuminated and observed in the wide-angle range.

The reflector of the present disclosure is preferably produced by the following method, which comprises the steps of providing a light-transmissive expandable substrate as the above substrate, providing the above retroreflective sheet and attaching the retroreflective sheet so that it covers the surface of the expandable substrate to form the above laminate, embossing the laminate to form depressions on said backside of the substrate, and projections on the reflection surface of the retroreflective sheet.

This method can precisely and easily form the above depressions and projections, which respectively have specific shapes, size and arrangement, and the above described functions (light converging and diffusing functions). Furthermore, this method can form depressions having the light-converging function and projections having the light-diffusing functions atop the depressions, so that the projections and depressions are present as closely as possible. Thus, the internal-lighting luminance of an internal-lighting display device in a wide observation angle range can be effectively enhanced.

### BRIEF DESCRIPTION OF THE DRAWINGS

FIG. 1 is a cross section of an internal-lighting display device comprising one example of a reflector according to the present invention.

FIG. 2 is a perspective view of one example of an internal-lighting display device according to the present invention.

### DETAILED DESCRIPTION

Reflector

Because of the synergistic effect of the depressions on the backside and the projections on the reflection surface of the retroreflective sheet, the reflector of the present disclosure can effectively improve the entrance angle characteristics of an external-lighting luminance and also can effectively enhance an internal-lighting luminance in a wide observation angle range.

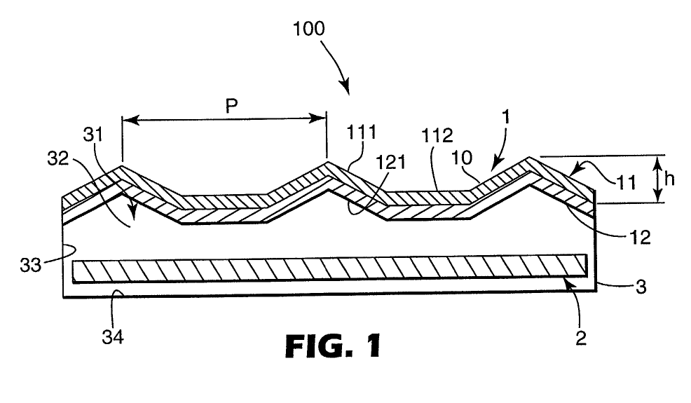

FIG. 1 shows one preferred embodiment of the reflector of the present invention.

In FIG. 1 showing a vertical cross section of the reflector 1, an area separating two adjacent projections 111 forms a substantially flat base part 112. The base part 112 is a part having a lower vertical height than the height of the top part (apex) of the projection 111. In the example of FIG. 1, both the projections 111 and the base part 112 are covered with the retroreflective sheet 11. In this example, the depressions 121 are formed from cavities, which are formed on the backsides of the projections 111 by embossing and the like, when the projections 111 are formed.

The following equation (I) provides a preferred and general relationship among various parameters to suitably design the sizes and arrangement of the projections 111 on the reflection surface in order to attain the above effects. Each parameter will be explained by making reference to FIG. 1. When the arrangement and sizes of the projections satisfy this equation, the projections follow a pattern formed by regularly repeated one or more geometric plane figures, and are arranged apart each other.

0.05<h/P<0.60 (I)

wherein P is a distance (pitch) between two adjacent projections, and h is the height of a projection from the surface of a base part.

When a plurality of P values are defined, the largest P value is used.

For example, the dot-like projections are disposed at the four apexes of a rhombus, P is a distance along the diagonal line between the apexes of two projections.

When a projection is a continuous ridge from one end to the other of a retroreflective sheet across the width of the sheet, P is a distance between the apexes of two projections in the vertical cross section of ridges (a cross section in the longitudinal direction of the retroreflective sheet) as shown in FIG. 1.

When the arrangement and sizes of the above ridges are determined according to the equation (I), the ridges are assumed to be arranged with striding two apexes of a rectangle in accordance with a pattern formed by regularly repeated rectangles. That is, ridges are provided on two parallel sides of the rectangle so that they face each other, and are arranged apart each other (discrete).

When the h/P ratio in the equation (I) is less than 0.05, an internal-lighting luminance is not enhanced at a relatively large observation angle (for example, 45 degrees or larger), so that the internal-lighting luminance may not be enhanced in a wide observation angle range. In the case of external lighting, the reflection luminance against the external light at a relatively high entrance angle may decrease.

When the h/P ratio is 0.60 or larger, the internal-lighting luminance in the front direction (internal-lighting front luminance) may deteriorate. In the case of external lighting, an entrance angle at which the sufficient, reflection luminance is attained may not be designed high (for example, 70 degrees or larger). From such a point of view, the h/P ratio of the equation (I) is preferably from 0.07 to 0.47, more preferably from 0.08 to 0.30.

A pitch P is usually at least 4 mm. When P is less than 4 mm, the internal-lighting luminance may decrease, and the reflection properties in relation to light at a high entrance angle may not be improved. When P is too large, the internal-lighting luminance at a relatively high observation angle is not improved so that the internal-lighting luminance may not be increased in a wide observation angle range. Furthermore, the improving effect on the reflection properties at a high entrance angle may deteriorate. From such a point of view, P is preferably in the range between 8 and 30 mm, more preferably in the range between 10 and 25 mm.

A height h is usually at least 0.5 mm. When h is less than 0.5 mm, the internal-lighting luminance in a wide observation angle range may not increase, and the reflection properties in relation to light at a high entrance angle may not be improved. When h is too large, it may be difficult to form information such as characters, designs, etc. on the reflector, which is used as a display plate of an internal-lighting display device. In addition, the retroreflective sheet may be broken when the projections are formed by embossing, etc. From such a point of view, h is preferably in the range between 1 and 10 mm, more preferably between 1.5 and 5 mm.

In the vertical cross section of a reflector, the width of the projection 111 (that is, a distance between boundary points between the projection 111 and adjacent base parts 112 in one projection area) is usually at least 5 mm, preferably from 10 to 40 mm, more preferably from 15 to 35 mm.

In the arrangement of projections, the projections are preferably disposed apart from each other on all the apexes of geometric plane figures according to patterns formed by regularly repeated one or more geometric plane figures.

Each projection is disposed so that the center of gravity (for example, a center in the case of a circle) of the bottom shape of the projection (that is, the horizontal cross section in the interfacial plane with the base parts) generally coincide with the apex of the geometric plane figure. The center of gravity of a figure can be mathematically obtained.

The shape of a geometric plane figure is not limited insofar as the above equation (I) is satisfied. For example, a geometric plane figure in the horizontal plane including the base parts may be a polygon such as a rectangle, a pentagon, a hexagon, etc.; a rhombus consisting of two triangles which are arranged so that the corresponding edges of the triangles are mated each other. When a plurality of geometric plane figures are included in an arrangement pattern, a plurality of P values are determined. In such a case, preferably all the P values satisfy the equation (I) to improve the reflection properties at high entrance angles.

The arrangement density of projections it determined so that the minimum horizontal size of the base part provided between two adjacent projections (for example, a size measured in a longitudinal direction of the retroreflective sheet shown in FIG. 1) is usually from 2 to 20 mm, preferably from 3 to 15 mm.

A shape of a projection in the vertical cross section may be a semicircle, a semiellipsoid, a truncated semicircle or semiellipsoid, a triangle, a trapezoid, a tetragon, etc. A plurality of projections may include those having two or more different three-dimensional shapes, insofar as the effects of the present invention are not impaired.

The arrangement and sizes of the depressions 121 formed on the backside of the substrate 12 are preferably determined in the same way as that employed to design those of the projections.

As described above, the depressions 121 are preferably provided as closely as possible to the projections 111. That is, the depressions 121 are preferably formed in the form of cavities on the backside of the projections 111 as shown in FIG. 1. However, depressions may be formed in the areas of the backside having no projections, usually, in the base parts.

The pitch of depression arrangement is usually at least 4 mm. When this pitch is less than 4 mm, the internal-lighting front luminance may decrease. When this pitch is too large, the arrangement density of depressions decreases so that the improving effect on the internal-lighting luminance may deteriorate. From such a point of view, the preferred pitch of the depressions is from 8 to 30 mm, more preferably from 10 to 25 mm.

The depth of a depression is usually at least 0.5 mm. When the depth is less than 0.5 mm, the internal-lighting front luminance may not increase. When the depth is too large, the strength of a reflector tends to decrease. From such a point of view, the depth of the depression is preferably from 1 to 10 mm, more preferably from 1.5 to 5 mm.

The width of a depression (see FIG. 1) is usually at least 5 mm. When the width of the depression is too small, an internal-lighting luminance may not increase in a wide observation angle range. When, the width is too large, an internal-lighting front luminance tends to decrease. From such a point of view, the width of the depression is preferably from 10 to 40 mm, more preferably from 15 to 35 mm.

The depressions are also preferably disposed apart from each other on all the apexes of geometric plane figures according to patterns formed by regularly repeating one or more geometric plane figures.

A shape of a depression in the vertical cross section may be a semicircle, a semiellipsoid, a truncated semicircle or semiellipsoid, a triangle, a trapezoid, a tetragon, etc. A plurality of depressions may include those having two or more different three-dimensional shapes, insofar as the effects of the present invention are not impaired.

When projections are in the form of ridges, they are disposed apart from each other through base parts. In such a case, the longitudinal direction of the ridge is usually in substantially parallel with the width direction of a substrate. To increase a reflection luminance with respect to a plurality of external-light beams having different entrance angles, a ridge may be of a crooked line or a curved line having a plurality of crooked portions or curved portions, rather than a straight line.

In general, the substrate, which is a constituent of a reflector, has a larger size in its lengthwise direction than that in its width direction. However, the sizes of a substrate in the lengthwise and width directions may be substantially the same, insofar as the effects of the present invention are not impaired.

Also, the retroreflective sheet usually has a larger size in its lengthwise direction than that in its width direction, but the sizes of a retroreflective sheet in the lengthwise and width directions may be substantially the same, insofar as the effects of the present invention are not impaired.

Thus, the reflector comprising such a substrate and the retroreflective sheet has a larger size in its lengthwise direction than that in its width direction, but the sizes of the reflector in the lengthwise and width directions may be substantially the same, insofar as the effects of the present invention are not impaired.

The light transmission of the reflector as a whole is usually at least 10%, preferably at least 12%, in particular at least 13%. The light transmission of the reflector is that measured from the backside (substrate side) of the reflector. Herein, a light transmission is a total light transmission measured according to JIS K 7105.

Substrate

Substrates are usually made of expandable metals or plastics. In particular, soft metals or soft plastics having good expendability are preferred, since they can be easily embossed, and projections and depressions can be easily formed.

Preferred examples of soft metals include aluminum, copper, silver, gold, etc. Preferred examples of soft plastics (e.g. thermoformable plastics) include acrylic resins, polycarbonate, polyester, polyethylene, polypropylene, polyvinyl chloride, etc.

The substrate should be light transmissive. The light transmission of the substrate is usually at least 30%, preferably at least 40%. When the substrate is made of a metal, a metal plate having a plurality of fine through holes, such as punching metal is used.

The thickness and properties such as tensile strength of substrates are not limited insofar as the effects of the present invention are not impaired. When the reflector is produced by embossing, the properties of the substrate are preferably selected as follows:

A preferred thickness is in a range between 0.05 and 2 mm for metals, or in a range between 0.1 to 5 mm for plastics. When the thickness of the substrate is too small, a substrate may be broken in the course or the formation of projections by embossing. When the thickness of the substrate is too large, it may be difficult to form projections by embossing.

The tensile strength of the substrate is usually from 1 to 15 kg/mm², preferably from 2 to 12 kg/mm². When the tensile strength of a substrate is too small, the substrate may be broken in the course of the formation of projections by embossing. When the tensile strength of a substrate is too large, it may be difficult to process the substrate.

Herein, the conditions to measure tensile properties such as a tensile strength, a strength at break, an elongation at break, etc. include a temperature of 20° C. and a pulling rate of 300 mm/min.

Retroreflective Layer

The light transmission of the retroreflective sheet used in the present invention is at least 10%, preferably at least 12%.

Preferably, a prism-type retroreflective sheet is used, which comprises a transparent prismatic film carrying prismatic reflective elements such as cube-corner prisms on its backside, and a sealing layer laminated on the backside to encapsulate the prismatic reflective elements under the sealing layer. In the prism-type retroreflective sheet, the surface of the transparent film (the flat surface carrying no prismatic reflective elements) functions as a reflective surface.

A preferred prismatic film is made of a resin having a light transmission of at least 70%, more preferably at least 80%, in particular at least 90%, and has a flat surface and a backside carrying a plurality of arranged prismatic projections (prismatic reflective elements). Such a prismatic film can achieve a high internal-lighting luminance and a reflection luminance in the absence of a metallic reflective film which decreases the transparency of the prismatic film.

Specific examples of retroreflective sheets include prismatic retroreflective sheets sold under the trade names of DIAMOND GRADE SHEET 3963, 3983, 3924, 3951, 3970 and 981 (all available from 3M); CRYSTAL GRADE SERIES (available from Nippon Carbide Industries Co., Ltd.), TRANSLUCENT 4600 SERIES (available from Stimsonite), or the like.

Prismatic retroreflective sheets may be produced by methods disclosed in JP-A-60-100103, JP-A-6-50111, U.S. Pat. No. 4,775,219. For example, a prismatic retroreflective sheet can be produced by shaping a plastic material with a mold having a specific size and design.

A preferred shape of a prismatic projection of a prismatic film is a triangular pyramid which is called a “cube corner”. Cube corner prisms can easily increase the reflection luminance and wide-angle observation properties of a prismatic film.

Preferred sizes of a triangular pyramid element include a bottom side length of 0.1 to 3.0 mm, and a height of 25 to 500 μm. The triangle of the bottom may be an equilateral triangle or an isosceles triangle, although it may be an inequilateral triangles the side lengths of which are slightly different each other.

A resin used to produce a prismatic film is preferably a highly transparent one having a refractive index of 1.4 to 1.7, for example, an acrylic resin, an epoxy-modified acrylic resin, a polycarbonate resin, etc.

A sealing layer may be a film made of a polyester resin having a total light transmission of at least 40%, preferably at least 50%. Besides the polyester resins, acrylic resins, polyurethane, vinyl chloride resins, polycarbonate, polyamide, polyvinyl fluoride, polybutyrate, etc. may be used to produce a sealing layer.

The thickness of a sealing layer is determined so that the light transmission of a retroreflective sheet is not impaired, and usually from 10 to 1,000 μM.

The light transmissive retroreflective sheet is produced by laminating the above sealing layer and the above prismatic film, and heat embossing them usually at a temperature higher than the softening point of the sealing layer, preferably in the range between 100 and 300° C. to form microcells having an air layer surrounded by sealing projections (parts of the prismatic film risen towards and adhered to the prismatic film).

An area of one microcell (an area of a region surrounded by sealing projections viewed from the surface of the prismatic film) is preferably from 2.5 to 40 mm², more preferably from 5 to 30 mm². The adhered area of the sealing projections is 10 to 85%, preferably 20 to 70% based on the whole area of the backside of the prismatic film. When the adhered area of the sealing projections exceeds 85%, a reflection luminance tends to decrease. When the adhered area is less than 10%, the adhesion strength decreases, and thus the sealing layer and the prismatic film may be delaminated.

The surface of a prismatic film is preferably covered with a highly transparent plastic film containing UV ray absorbers and having good weather resistance (for example, a film of an acrylic resin or a blend of an acrylic resin and a fluororesin).

The properties of the retroreflective sheets such as elongation at break, strength at break, thickness, etc. are not limited insofar as the effects of the present invention are not impaired. However, when the reflectors are produced by embossing, such properties of the retroreflective sheets are preferably selected as follows:

Elongation at break is preferably from 5 to 300%, more preferably from 10 to 280%. When the elongation at break exceeds 300%, the reflective surface of the reflector may be wrinkled in the course of embossing. When the elongation at break is less than 5%, the embossing of a sheet may be difficult.

Strength at break is usually from 1.0 to 10.0 kg/25 mm, preferably from 3.0 to 7.0 kg/25 mm. When the strength at break is less than 1.0 kg/25 mm, the reflective sheet may be broken in the course of embossing. When the strength at break exceeds 10 kg/25 mm, the embossing of a sheet may be difficult.

The thickness of the retroreflective sheet is preferably in a range between 50 and 750 μm. When this thickness is less than 50 μm, the retroreflective sheet may become more susceptible to breaking in the course of embossing. When this thickness exceeds 750 μm, the embossing of a sheet may be difficult or require more effort.

The prismatic film and/or the sealing layer may contain various additives, insofar as the effects of the present invention are not impaired. Examples of additives include colorants such as fluorescent dyes, fluorescent pigments, etc., plasticizers, surfactants, curing agents, fillers such as diffusively reflection particles, etc., stabilizers for enhancing heat resistance, antioxidant or UV ray resistance, and the like.

An adhesive may be used to fix a retroreflective sheet to a substrate. Examples of adhesives include acrylic adhesives, polyolefin adhesives, polyurethane adhesives, silicone adhesives, epoxy adhesives, etc. Adhesives may be pressure-sensitive adhesives, heat-sensitive adhesives (including hot-melt adhesives), curable adhesives, etc. Pressure-sensitive adhesives are preferred, since they have good flowability and thus facilitate the formation of projections by embossing.

In general, an adhesive is provided in the form of a layer between a substrate and a reflective sheet, and the layer has a thickness of 5 to 50 μm.

Production of Reflector

The reflector of the present invention is preferably prepared by a method including the formation step of projections and depressions by embossing, as described above.

Embossing is carried out by pressing an embossing tool, which has a plurality of projections having specific shapes, sizes and arrangement, to the backside of a laminate, that is the backside of a substrate. The shapes, sizes and arrangement of the projections of an embossing tool are designed so that they correspond to those of the projections and depressions of a reflector.

A pressure in the embossing process is usually from 1 to 100 kg/cm², preferably from 20 to 80 kg/cm². A pressure is applied by pressing with, for example, a mechanical press, a vacuum press, etc.

As an embossing tool, a pair of the first and second tools may be used. The first tool is composed of a plate or a roll having the above-described projections on its surface, and the second tool which touches the surface of a retroreflective sheet. The second tool may have depressions which receive the projections of the first tool, or a flat surface made of a material which can deform when the first tool is pressed to the second tool from the backside of a substrate. A material of the second tool used in the latter type may be a rubber, an elastomer, etc.

When a substrate is made of an expandable plastic, it is preferable to avoid the whitening of the parts of the substrate which are folded by embossing, and the decrease of the light transmission of a reflector as a whole. To avoid such whitening, the embossing is carried out while applying heat to a laminate.

A heating temperature is preferably selected so that the temperature of the substrate of a laminate is at least a glass transition temperature of a plastic of the substrate. A heating temperature is suitably selected according to the material of a substrate, and usually from 30 to 200° C.

The same conditions and embossing tool as described above can be used in the production method by embossing in which a retroreflective sheet and a laminate having an adhesive-layer protected with a liner are respectively formed on the surface and backside of a substrate, and the embossing tool having a plurality of projections is pressed onto the liner of the laminate to form projections.

A substrate may be embossed after characters or designs are printed on the surface of the covering layer of a retroreflective sheet.

Alternatively, the reflector of the present invention can be produced by laminating a retroreflective sheet on a substrate, which has the already formed projections, and then press-bonding the substrate and the reflective sheet under reduced pressure.

Application of Reflector

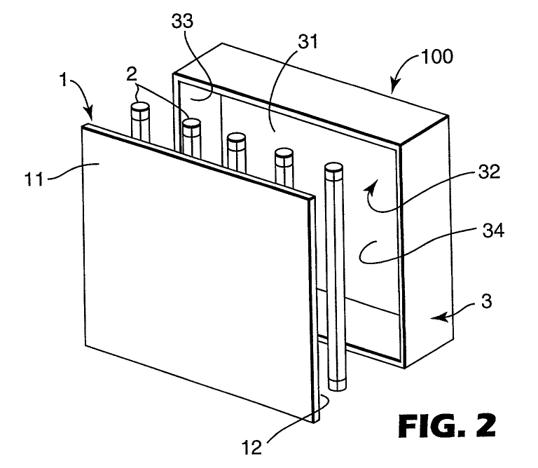

As described above, the reflector of the present invention can be suitably used to form a display surface of an internal-lighting display device. The internal-lighting display device of the present invention generally has a structure shown in FIG. 2. That is, the internal-lighting display device 100 comprises:

A: at least one built-in light source 2,

B: a housing 3 having a space 32 which contains the built-in light source 2, and at least one opening continuous with said space 32, and

C: a reflector 1 of the present disclosure, which is provided to cover the opening 31 with the backside of the substrate facing the opening 31 of the housing 3.

In FIG. 2, projections on the reflection surface of the retroreflective sheet 11, and depressions on the backside of the substrate 12 are not shown. Though not shown, sign information (characters, designs, etc.) may be provided on the reflection surface of the retroreflective sheet 11 of the reflector 1.

The light source 2 may advantageously be a fluorescent tube, a cool cathode tube, a xenon lamp, a halogen lamp, a flash lamp, a side-lighting type optical fiber, etc.

A consumed electric power by a light source is usually from 10 to 500 W. Sunlight can be converged and introduced in one end of a fiber core of an optical fiber.

When a retroreflective sheet contains a fluorescent material such as a fluorescent dye, a light source, which emits light having a wavelength band specified in accordance with an excitation wavelength of such a fluorescent material, is used. For example, a light source used in combination with a yellow-green type, orange type or yellow type fluorescent material is preferably a fluorescent light source such as a fluorescent lamp, which emits blue or green light. Preferred examples of such fluorescent light sources include a fluorescent lamp “COLOR HID-Blue” and a “COLOR TWIN fluorescent lamp” (both manufactured by Matsushita Electric Industrial Co., Ltd.).

In order to effectively develop a fluorescent color (that is, to improve the visibility) and to allow the colored surface of a reflector to be seen brightly, light from a light source preferably has a gentle broad spectral distribution over the excitation wavelength band rather than a relatively narrow spectral distribution concentrated at a part of the excitation wavelength band of a fluorescent material.

It may be possible to use a backlight unit for a liquid crystal display instead of the combination of the above light source A and the housing B. Such a backlight unit may comprise (1) a light-guide plate having a light-emitting surface and side faces perpendicular to the light-emitting surface, and (2) at least one light source to introduce light into the light-guide plate through the side face thereof When such a backlight unit is used, it is possible to reduce the thickness of an internal-lighting display device.

Alternatively, an electroluminescent (EL) sheet may be used instead of the combination of the above light source A and the housing B.

The size of a light-emitting surface (a reflection surface of a reflector) is not limited, but embodiments usually range from 100 cm² to 2 m².

In the embodiment shown in FIG. 2, the housing 3 may be assembled from parts of plastics, metals, wood plates, etc.

It is preferable to provide a reflection layer on inner walls facing the space 32 of the housing, that is, four side walls 33, and the back wall 34. Thus, the light of a light source can be effectively supplied to the reflector, and the internal-lighting luminance can be further effectively increased. A reflection layer may be a mirror reflection film such as a metal-deposited film, a dielectric reflection mirror film, etc., or a white diffusing film.

The reflector 1 is fixed to the edges (parts forming a rectangular frame in FIG. 2) of the side walls 33 defining the opening 31. The reflector can be fixed with, for example, an adhesive. When the reflector 1 is disposed, the reflector 1 and the housing 3 are closely adhered so that the light of a light source does not leak from any parts except the reflection surface of the reflector.

An optical element such as a diffusive light-transmitting film, a prism lens film, a color filter, etc. may be disposed between the light source 2 and the reflector 1, insofar as the effects of the present invention are not impaired.

The internal-lighting display device of the present invention is particularly useful as an internal-lighting sign such as an internal-lighting traffic sign or an internal-lighting delineator, which is installed on the road side or put on the wall of a tunnel. Furthermore, the internal-lighting display device of the present invention may be fixed onto the surface of a material such as a guardrail, a signboard or a display board.

After the display device is installed outdoors, it is periodically cleaned to maintain the cleanness of the reflection surface of the reflector. However, it is preferable that, after cleaning, the contaminated surface can be cleaned by a self-cleaning mechanism to keep the cleanness of the surface until the next cleaning. To this end, it is preferable to coat a reflection surface with a light transmissive protective film containing a photocatalyst such as titanium oxide, or to use a self-cleaning member. A self-cleaning member may be a thin piece such as a cloth or a film, or a brush.

### EXAMPLES

Example 1

An expandable plastic sheet was used as a substrate, and a prism-type reflective sheet No. 3963 (manufactured by 3M) was used as a retroreflective sheet. The plastic was an acrylic resin. The sheet had a thickness of 1.0 mm, a tensile strength of 5 kg/mm², and a total light transmission of 95%. The retroreflective sheet had a thickness of 400 μm, elongation at break of 10%, a tensile strength at break of 9 kg/25 mm, and a total light transmission of 15%.

The retroreflective sheet and the substrate were adhered with an acrylic adhesive which was provided on the backside of the retroreflective sheet to obtain a laminate consisting of the retroreflective sheet and the substrate. The laminate had a total light transmission of 13.7%.

The obtained laminate was embossed to finish the reflector of the present invention.

A plurality of projections of an embossing tool were pressed on the backside of the substrate (an opposite surface to the retroreflective sheet).

The embossing was carried out using a tool consisting of the combination of the first tool having projections and the second tool having depressions to receive the projections of the first tool under an embossing pressure of about 70 kg/cm². The embossing tools were heated at 120° C.

In the reflector of this Example, the projections on the reflection surface were a plurality of ridges which extended in parallel with each other along the width direction of the substrate (that is, the width direction of the finished reflector) as shown in FIG. 1. The width of each ridge was 25 mm, the pitch P was 15 mm, and the height h was 5 mm.

The reflector had a longitudinal size (length) of 50 cm, and a widthwise size (width) of 20 cm. The depressions of the substrate were formed as cavities on the backside of the projections on the reflection surface. Each depression had a width of 24 mm and a depth of 4.5 mm.

### Comparative Example 1

A reflector was produced in the same manner as in Example 1 except that a laminate was not embossed.

### Example 2

A reflector was produced in the same manner as in Example 1 except that an aluminum punching metal was used as a substrate, and the embossing tools were not heated. The substrate had a thickness of 0.3 mm and a tensile strength of 5 kg/mm².

The substrate had through-holes having a diameter of 3 mm, and the pitch of the arranged through-holes was 5 mm. The opening percentage (a percentage of the through-holes based on the whole substrate area) was 56%.

### Comparative Example 2

A reflector was produced in the same manner as in Example 2 except that a laminate was not embossed.

Evaluation of Reflector

The reflector produced in each Example was disposed at the opening of a housing having a built-in light source with the substrate side facing the space of the housing to assemble an internal-lighting display device, which had the structure shown in FIG. 2.

The opening of the housing was a rectangular shape of 25 cm in length and 27 cm in width, and the depth of the housing (a distance from the opening to the back wall of the housing) was 10 cm. The housing was assembled by connecting white polycarbonate plates, and a pair of COLOR TWIN luminescent lamps 2-27 W (manufactured by Matsushita Electric Industrial Co., Ltd.) were used as light sources.

An internal-lighting luminance was measured with each of the internal-lighting display devices assembled using the reflectors of Examples and Comparative Examples. A used luminance meter was Luminance meter LS-110 (manufactured by MINOLTA).

TABLE 1

| | Front luminance | Luminance at | Luminance at |
|---|---|---|---|
| | (Observation | observation | observation |
| | angle of 0° ) | angle of 45° | angle of 60° |
| | (cd/m²) | (cd/m²) | (cd/m²) |
| Ex. 1 | 420 | 435 | 430 |
| C. Ex. 1 | 350 | 360 | 350 |
| Ex. 2 | 160 | 220 | 210 |
| C. Ex. 2 | 118 | 160 | 158 |

1. A reflector comprising a laminate having a light-transmissive substrate and a light-transmissive retroreflective sheet attached to said substrate to cover the surface of said substrate, wherein said reflector has light-transmission properties as a whole, characterized in that, a plurality of depressions are formed on the backside of said substrate, and a plurality of projections are formed on a reflection surface of said retroreflective sheet.

2. A method for the production of a reflector of claim 1, comprising the steps of:
(a) providing a light-transmissive expandable substrate as said substrate,
(b) providing said retroreflective sheet and attaching said retroreflective-sheet so that it covers the surface of said expandable substrate to form said laminate,
(c) embossing said laminate to form said depressions on said backside of said substrate, and said projections on the reflection surface of said retroreflective sheet.

3. An internal-lighting display device comprising:
A: a light source,
B: a housing having a space which contains a built-in light source, and at least one opening continuous with said space, and
C: a reflector of claim 1, which is provided to cover said opening with the backside of said substrate facing said opening of said housing.
